(19) United States
(12) Patent Application Publication
(10) Pub. No.: US 2026/0111037 A1
(43) Pub. Date: Apr. 23, 2026

(54) SYSTEM AND METHOD OF URBAN AIR MOBILITY FLEET MANAGEMENT

(71) Applicant: HONEYWELL INTERNATIONAL INC., Charlotte, NC (US)

(72) Inventors: Karthikeyan M, Madurai (IN); Gobinathan Baladhandapani, Madurai (IN); Pradeep Huncha, Madurai (IN)

(73) Assignee: HONEYWELL INTERNATIONAL INC., Charlotte, NC (US)

(21) Appl. No.: 18/966,814

(22) Filed: Dec. 3, 2024

(30) Foreign Application Priority Data
Oct. 18, 2024 (IN) 202411079273

(51) Int. Cl. G05D 1/667; G05D 1/644; G05D 1/698; G05D 105/28

(52) U.S. Cl. CPC G05D 1/667; G05D 1/644; G05D 1/698; G05D 2105/28

(57) ABSTRACT

A method in an Urban Air Mobility (UAM) system includes: receiving user input including an identification of a specific payload, a pickup location for the payload, a destination for the payload, and a user-selected mission priority for the payload from a plurality of user-selectable mission priorities; applying a fleet utilization algorithm with a plurality of selection algorithms that determine one or more UAM vehicles to dispatch on a mission; selecting an appropriate selection algorithm out of the plurality of selection algorithms based on the user-selected mission priority; applying the appropriate selection algorithm to the user input to select the one or more UAM vehicles to transport the specific payload; and generate a human machine interface (HMI) display configured for display on a display device, the HMI display including a map that illustrates the pickup location, destination, and the one or more UAM vehicles assigned to transport the specific payload.

### CROSS REFERENCE TO RELATED APPLICATION

This application claims priority to India Provisional Patent Application No. 202411079273, filed Oct. 18, 2024 the entire content of which is incorporated by reference herein.

### TECHNICAL FIELD

The technical field generally relates to urban air mobility fleet management, and more particularly relates to systems and methods for dispatching urban air mobility vehicles on transport missions.

### BACKGROUND

An Urban Air Mobility (UAM) system is an aviation transportation system that uses highly automated aircraft that operate and transport passengers or cargo at lower altitudes within urban and suburban areas. The highly automated aircraft can include unmanned vehicles. Ground tools are needed to manage the unmanned vehicles.

Hence, it is desirable to provide systems and methods for assisting with managing the unmanned vehicles. Furthermore, other desirable features and characteristics of the present disclosure will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In some aspects, the techniques described herein relate to an Urban Air Mobility (UAM) system including: a plurality of UAM vehicles distributed at a plurality of UAM stations at different locations; a ground control station including a display screen and configured for use by one or more ground control station operators to dispatch one or more UAM vehicles from the plurality of UAM vehicles on a mission; and a fleet manager system including a processor configured by programming instructions to: receive user input including an identification of a specific payload, a pickup location for the payload, a destination for the payload, and a user-selected mission priority for the payload from a plurality of user-selectable mission priorities; apply a fleet utilization algorithm with a plurality of different selection algorithms that determine the one or more UAM vehicles to dispatch on a mission; select an appropriate selection algorithm out of the plurality of different selection algorithms based on the user-selected mission priority; apply the appropriate selection algorithm to the user input to select the one or more UAM vehicles to transport the specific payload; and generate a human machine interface (HMI) display configured for display on the ground control station, the HMI display configured to illustrate the pickup location, destination, and the one or more UAM vehicles assigned to transport the specific payload.

In some aspects, the techniques described herein relate to a UAM system, wherein the plurality of user-selectable mission priorities include a plurality of: a first mission priority that prioritizes time efficiency; a second mission priority that prioritizes route efficiency; a third mission priority that prioritizes fleet efficiency; a fourth mission priority that prioritizes delivery urgency; and a fifth mission priority that prioritizes a single vehicle mission, wherein a single UAM vehicle is dispatched to carry the payload.

In some aspects, the techniques described herein relate to a UAM system, wherein the plurality of different selection algorithms include a plurality of a time-efficient selection algorithm, a route-efficient selection algorithm, a fleet-efficient selection algorithm, an emergency selection algorithm, and a single-vehicle selection algorithm, and wherein: the time-efficient selection algorithm is selected when a user-selected mission priority prioritizes time efficiency; the route-efficient selection algorithm is selected when a user-selected mission priority prioritizes route efficiency; the fleet-efficient selection algorithm is selected when a user-selected mission priority prioritizes fleet efficiency; the emergency selection algorithm is selected when a user-selected mission priority prioritizes delivery urgency; and the single-vehicle selection algorithm is selected when a user-selected mission priority prioritizes a single vehicle mission.

In some aspects, the techniques described herein relate to a UAM system, wherein the HMI display includes: a two-dimensional (2-D) map; and a GUI widget displayed over the 2-D map, the GUI widget configured for user selection of one of the plurality of user-selectable mission priorities.

In some aspects, the techniques described herein relate to a UAM system, wherein the GUI widget further includes a selectable element that when selected causes the fleet manager system to assign the one or more UAM vehicles to transport the specific payload based on the user-selected mission priority.

In some aspects, the techniques described herein relate to a method in an Urban Air Mobility (UAM) system, the method including: receiving user input including an identification of a specific payload, a pickup location for the payload, a destination for the payload, and a user-selected mission priority for the payload from a plurality of user-selectable mission priorities; applying a fleet utilization algorithm with a plurality of different selection algorithms that determine one or more UAM vehicles to dispatch on a mission; selecting an appropriate selection algorithm out of the plurality of different selection algorithms based on the user-selected mission priority; applying the appropriate selection algorithm to the user input to select the one or more UAM vehicles to transport the specific payload; and generate a human machine interface (HMI) display configured for display on a display device, the HMI display including a map that illustrates the pickup location, destination, and the one or more UAM vehicles assigned to transport the specific payload.

In some aspects, the techniques described herein relate to an Urban Air Mobility (UAM) system including: a plurality of UAM vehicles distributed at a plurality of UAM vehicle stations at different locations; a ground control station including a display screen and configured for use by one or more ground control station operators to dispatch one or more UAM vehicles from the plurality of UAM vehicles on a mission; and a fleet manager system including a processor configured by programming instructions to: receive user input including an identification of a specific payload, a pickup location for the specific payload, a destination for the specific payload, a delivery time for payload delivery, and a mission type; partition a flight path from the pickup location to the destination into a plurality of segments, wherein a first segment begins at the pickup location and ends at a waypoint and a last segment begins at a waypoint and ends at the destination; assign one or more UAM vehicles to transport the specific payload along one or more segments based on an assigned mission priority; wherein when the assigned mission priority prioritizes time efficiency, the fleet manager system selects one or more UAM vehicles to transport the specific payload based on minimizing waiting time at the pickup location and any waypoint; wherein when the assigned mission priority prioritizes route efficiency, the fleet manager system selects one or more UAM vehicles currently tasked with transporting another payload along the one or more segments to transport the specific payload based on energy capacity and payload carrying capacity of the one or more UAM vehicles; wherein when the assigned mission priority prioritizes fleet efficiency, the fleet manager system selects one or more UAM vehicles based on optimizing UAM vehicle availability at UAM vehicle stations; wherein when the assigned mission priority prioritizes delivery urgency, the fleet manager system selects one or more UAM vehicles based on minimizing delivery time for the specific payload; and generate a human machine interface (HMI) display configured for display on the ground control station, the HMI display configured to illustrate the pickup location, destination, the plurality of segments, and the one or more UAM vehicles selected to transport the payload.

In some aspects, the techniques described herein relate to a non-transitory computer readable medium having stored thereon instructions that when executed by a processor cause the processor to perform a method including: receiving user input including an identification of a specific payload, a pickup location for the payload, a destination for the payload, and a user-selected mission priority for the payload from a plurality of user-selectable mission priorities; applying a fleet utilization algorithm with a plurality of different selection algorithms that determine one or more UAM vehicles to dispatch on a mission; selecting an appropriate selection algorithm out of the plurality of different selection algorithms based on the user-selected mission priority; applying the appropriate selection algorithm to the user input to select the one or more UAM vehicles to transport the specific payload; and generate a human machine interface (HMI) display configured for display on display device, the HMI display including a map that illustrates the pickup location, destination, and the one or more UAM vehicles assigned to transport the specific payload.

Furthermore, other desirable features and characteristics will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a block diagram depicting an example airspace network for a UAM system, in accordance with some embodiments.

FIG. 2 is a block diagram depicting an example ground control station, in accordance with some embodiments.

FIG. 3 is a block diagram depicting an example fleet manager system, in accordance with some embodiments.

FIG. 4 is a block diagram depicting an example fleet utilization algorithm, in accordance with some embodiments.

FIG. 5 is a process flow chart depicting an example method in a system that utilizes a fleet utilization algorithm, in accordance with some embodiments.

FIG. 6 is a process flow chart of an example method in an Urban Air Mobility (UAM) system, in accordance with some embodiments.

FIG. 7 is a diagram depicting an example HMI display generated by a fleet manager controller for an operating scenario, in accordance with some embodiments.

FIG. 8 is a diagram depicting an example HMI display generated by a fleet manager controller for an operating scenario, in accordance with some embodiments.

FIG. 9 is a diagram depicting an example HMI display generated by a fleet manager controller for an operating scenario, in accordance with some embodiments.

FIG. 10 is a diagram depicting an example HMI display generated by a fleet manager controller for an operating scenario, in accordance with some embodiments.

FIG. 11 is a diagram depicting an example HMI display generated by a fleet manager controller for an operating scenario, in accordance with some embodiments.

FIG. 12 is a diagram depicting an example HMI display generated by a fleet manager controller for an operating scenario, in accordance with some embodiments.

FIG. 13 is a diagram depicting an example HMI display generated by a fleet manager controller for an operating scenario, in accordance with some embodiments.

### DETAILED DESCRIPTION

The following detailed description is merely exemplary in nature and is not intended to limit the invention or the application and uses of the invention. As used herein, the words “exemplary” and “example” mean “serving as an example, instance, or illustration.” Thus, any embodiment described herein as “exemplary” or “example” are not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Unmanned Aerial Vehicles (UAVs) are widely used for various missions such as surveillance, reconnaissance, mapping, transport, and delivery. Some missions may require transporting a large payload that exceeds the capacity of a single UAV. In such cases, multiple UAVs can cooperate to carry a common payload to complete a desired mission. Payload as used throughout this document may refer to a cargo payload or a passenger detachable capsule. The apparatus, systems, techniques, and articles provided herein can select multiple flying vehicles for transporting a common payload, which aims to optimize the flight time, energy consumption, and safety of the vehicles.

The apparatus, systems, techniques, and articles provided herein can assist with efficient fleet management for payload delivery. The apparatus, systems, techniques, and articles provided herein can assign the right UAV for a given cargo payload and/or number of passengers. In various embodiments, the apparatus, systems, techniques, and articles provided herein can dynamically optimize a route based on payload additions at different stations. In various embodiments, the apparatus, systems, techniques, and articles provided herein can reduce payload waiting time by ensuring the availability of vehicle. The apparatus, systems, techniques, and articles provided herein can assist with efficient battery charging management. In various embodiments, the apparatus, systems, techniques, and articles provided herein can account for environmental restrictions such as port size, noise restrictions, and high altitude flying for safety reasons when assigning vehicles for a mission. In various embodiments, the apparatus, systems, techniques, and articles provided herein can account for Dynamics such as operating in congested areas and weather conditions when assigning vehicles for a mission. In various embodiments, the apparatus, systems, techniques, and articles provided herein considers various factors such as energy, mission objectives, and vehicle availability based on the user inputs (payload/number of passengers or time) when assigning vehicles for a mission. In various embodiments, the apparatus, systems, techniques, and articles provided herein can collectively manage fleets in real-time (dynamically) to increase the range and endurance for the given payload and time criticality by analyzing the fleet's performance and availability of the vehicles at different hubs. In various embodiments, the apparatus, systems, techniques, and articles provided herein can offer fleet management through a ground control station interface. In various embodiments, the apparatus, systems, techniques, and articles provided herein can access vehicle information, vehicle health data, environmental data, fuel station data, battery charging station data via the cloud for use in generating an efficient flight plan.

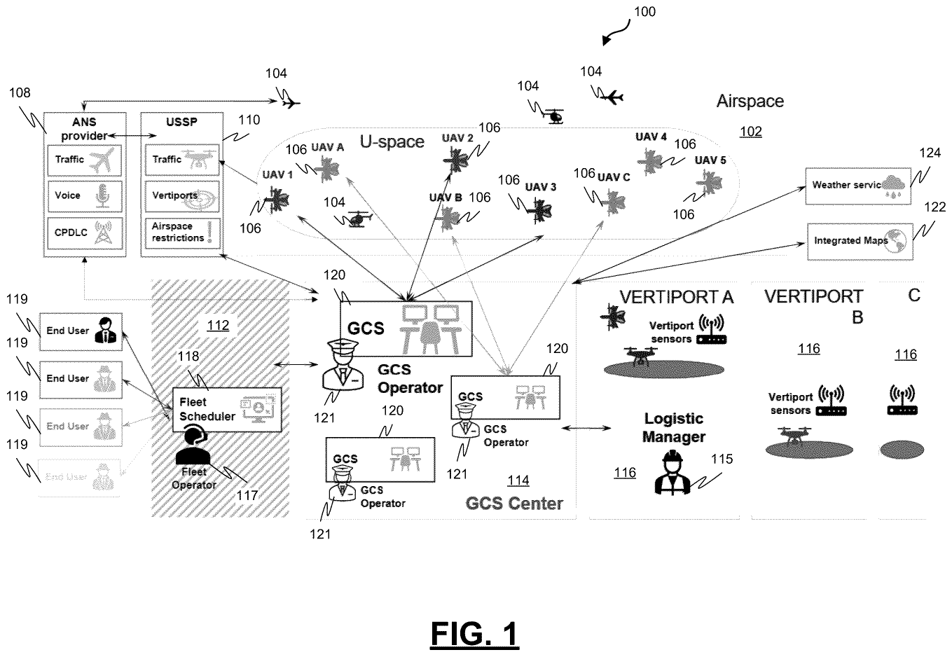

An Urban Air Mobility (UAM) system is an aviation transportation system that uses highly automated aircraft that operate and transport passengers or cargo at lower altitudes within urban and suburban areas. FIG. 1 is a block diagram depicting an example airspace network 100 for a UAM system. The example airspace network 100 includes an airspace 102 that includes a plurality of aerial vehicles. The plurality of aerial vehicles in the airspace 102 includes a plurality of manned aerial vehicles 104 and a plurality of unmanned aerial vehicles (UAVs) 106.

The example airspace network 100 further includes an ATC (air traffic control) service provider 108 that provides air traffic control services for the plurality of manned aerial vehicles 104 in the airspace, and an unmanned aircraft system traffic management (UTM) service provider 110 that provides traffic management services for the plurality of UAVs 106 in the airspace 102. The ATC (air traffic control) service provider 108 coordinates with the unmanned aircraft system traffic management (UTM) service provider 110. The example airspace network 100 also includes one or more fleet scheduler centers 112, one or more ground control station centers 114, and one or more vertiports 116.

A vertiport 116 is an area of land, water, or structure used or intended to be used for the landing and take-off of VTOL (Vertical Take-off and Landing) vehicles. A fleet scheduler center 112 includes fleet scheduler infrastructure 118 for a fleet operator 117. The fleet operator 117 is responsible for scheduling transportation for end users 119. A ground control station center 114 includes one or more ground control stations 120 for one or more ground control station operators 121. In a UAM environment, a ground operator 121 monitors multiple ongoing missions (e.g., delivery, cargo, air taxi, etc.) of autonomous or semi-autonomous UAM vehicles (e.g., eVTOL (electric Vertical Take-off and Landing vehicle), VTOL (Vertical Take-off and Landing vehicle), UAV (Unmanned Aerial Vehicle), drones, etc.) from the ground and makes mission-specific decisions. The ground operator 121 uses a ground control station (GCS 120) in the performance of its duties.

In some embodiments, the UAM is operated in an airspace controlled by a UTM service provider 110, who will be responsible for traffic deconfliction and overall airspace management. In some embodiments, the missions of UAM vehicles in the airspace will be managed by the ground operators 121, who is responsible for each vehicle under its supervision, the mission success, dispatch, surveillance, flight plan (FPLN) changes due to contingencies, etc. A high-tech GCS 120 with an easy to use, easy to learn human-machine interface (HMI), can effectively support a ground operator's tasks and decisions related to the UAM fleet management.

In support of its duties, the ground operator 121 receives notification items via the GCS 120 from many sources. Notification items are messages from sources such as a UAM vehicle (e.g., an UAV 106), an ATC service provider 108, a UTM service provider 110, a fleet scheduler center 112, a logistic manager 115 at a vertiport 116, an integrated map provider 122, and a weather service provider 124 that may have an impact on how the ground operator 121 manages the missions of the UAM vehicle under its supervision.

An example GCS 120 includes a set of tools, including hardware, software, and a human-machine interface, to support a ground operator 121 during fleet management and control. The GCS 120 forms a relational network with the plurality of UAM vehicles, ATC service provider 108, UTM service provider 110, fleet scheduler center 112, a vertiports 116, integrated map provider 122, and weather service provider 124 to receive notification items therefrom. As used herein the term “relational network” refers to any network in which the various constituents of the network work together to accomplish a purpose.

The example GCS 120 further includes functionality to support a ground operator 121 when dispatching UAM vehicles on missions. The example GCS 120 includes a display screen and is configured for use by one or more ground control station operators to dispatch one or more UAM vehicles from a plurality of UAM vehicles on a mission. The example GCS 120 is used in connection with a fleet manager system that may be embodied within the GCS 120 or embodied within other equipment.

The fleet manager system, whether embodied within the GCS 120 or outside of the GCS 120, includes a processor configured by programming instructions to: receive user input including an identification of a specific payload, a pickup location for the specific payload, a destination for the specific payload, a delivery time for payload delivery, and a mission priority for the specific payload. The specific payload may include passenger transport and/or goods transport.

The processor of the fleet manager system is further configured to apply a fleet utilization algorithm configured to select UAM vehicles for dispatch on a mission based on a user-selected mission priority from the plurality of user-selectable mission priorities. In various embodiments, the fleet utilization algorithm includes a plurality of different selection algorithms. In various embodiments, each user-selectable mission priority corresponds to a different one of the plurality of selection algorithms in the fleet utilization algorithm for determining the one or more UAM vehicles to dispatch on the mission.

In various embodiments, the plurality of user-selectable mission priorities include one or more of: a first mission priority that prioritizes time efficiency; a second mission priority that prioritizes route efficiency; a third mission priority that prioritizes fleet efficiency; a fourth mission priority that prioritizes delivery urgency; and a fifth mission priority that prioritizes a single vehicle mission, wherein a single UAM vehicle is dispatched to carry the entire payload. In various embodiments, one or more UAM vehicles are allocated for mission completion to minimize payload wait time when the mission priority prioritizes time efficiency. In various embodiments, a UAM vehicle with sufficient payload carrying capacity is allocated for transporting a plurality of packages with different pickup locations along a route to different or the same destination when the mission priority prioritizes route efficiency. In various embodiments, a first UAM vehicle on a first mission is directed to drop its load at a station and divert to a second mission when a second UAM vehicle is available to complete the first mission and it is more efficient for the first UAM vehicle to complete the second mission than dispatching another UAM vehicle to complete the second mission when the mission priority prioritizes fleet efficiency. In various embodiments, a first UAM vehicle is dispatched to transport a first payload directly from a first pickup station to a first destination station without diversion to another station and without diversion to another mission when the mission priority prioritizes delivery urgency. In various embodiments, a single UAM vehicle is dispatched to carry the entire payload when the mission priority prioritizes a single vehicle mission.

The processor of the fleet manager system is also configured to generate a human machine interface (HMI) configured for display on the GCS 120. In various embodiments, the HMI is configured to display a map that illustrates the pickup location and destination for each of the one or more UAM vehicles assigned to transport the payload.

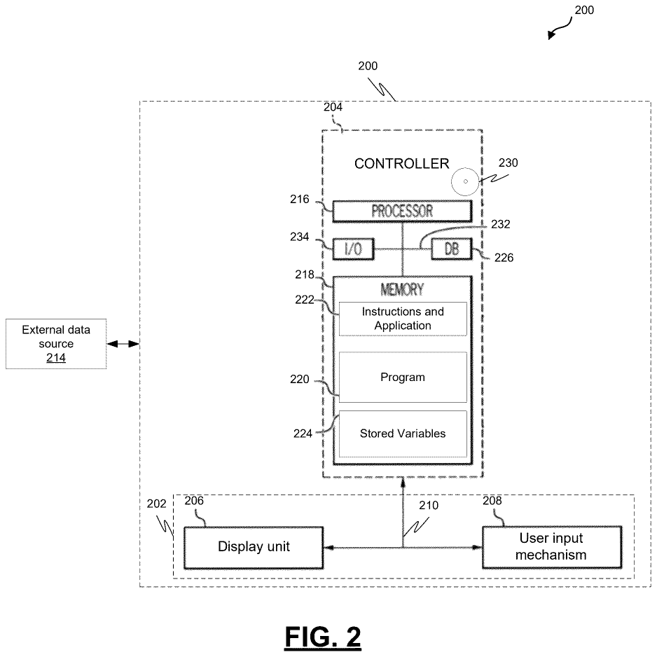

FIG. 2 is a block diagram depicting an example ground control station 200 (e.g., GCS 120). The example ground control station 200 includes an HMI device 202 and a system controller 204 (e.g., an electronics control unit). The HMI device 202 has at least one display unit 206 and at least one user input mechanism 208. In various embodiments, the HMI device 202 includes a touchscreen device having at least one touchscreen display as a display unit and a touchscreen surface as a user input mechanism. In various embodiments, the HMI device 202 includes a mouse and/or keyboard as user input mechanisms.

The system controller 204 may be operationally coupled to a plurality of the following ground control station systems: the display unit 206, the user input mechanism 208, and a communication system and fabric 210. The operation of these functional blocks is described in more detail below.

In various embodiments, the communication system and fabric 210 is configured to support instantaneous (i.e., real time or current) communications between the system controller 204, display unit 206, and user input mechanism 208. The communication fabric 210 may incorporate one or more transmitters, receivers, and the supporting communications hardware and software required for components of the ground control station 200 to communicate as described herein.

The communication system and fabric 210 is also configured to support communications between external data source(s) 214 and the ground control station 200. External data source(s) 214 may comprise a UAM vehicle (e.g., an UAV 106), an ATC service provider 108, a UTM service provider 110, a fleet scheduler center 112, a logistic manager 115 at a vertiport 116, an integrated map provider 122, a weather service provider 124, cloud-based databases, and others. Data received from the external data source(s) 214 may include notification items or other data. In this regard, the communication system and fabric 210 may be realized using a radio communication system or another suitable data link system.

The user input mechanism 208 is coupled to the system controller 204, and the user input mechanism 208 and the system controller 204 are cooperatively configured to allow a user (e.g., a GCS supervisor) to interact with the display unit 206 and/or other elements of the ground control station 200 in a conventional manner. The user input mechanism 208 may include any one, or combination, of various known user input device devices including, but not limited to: a touch sensitive screen; a cursor control device (CCD), such as a mouse, a trackball, or joystick; a keyboard; one or more buttons, switches, or knobs; a voice input system; and a gesture recognition system. In embodiments using a touch sensitive screen, the user input mechanism 208 may be integrated with a display unit. Non-limiting examples of uses for the user input mechanism 208 include: entering values for stored variables 224, loading or updating instructions and applications 222, and loading and updating the contents of the database 226, each described in more detail below.

The display unit 206 may include any device or apparatus suitable for displaying notification items, UAM vehicle assignment information, or other data associated with operation of the ground control station 200 in a format viewable by a user. Display methods include various types of computer-generated symbols, text, and graphic information representing, for example, an identification of a specific payload, a pickup location for the specific payload, a destination for the specific payload, a delivery time for payload delivery, a mission priority for the specific payload, or other data in an integrated, multi-color or monochrome form. The display unit 206 may comprise display devices that provide three dimensional or two-dimensional images and may provide synthetic vision imaging. Non-limiting examples of such display units include cathode ray tube (CRT) displays, and flat panel displays such as LCD (liquid crystal displays) and TFT (thin film transistor) displays. Accordingly, each display unit responds to a communication protocol that is either two-dimensional or three, and may support the overlay of text, alphanumeric information, or visual symbology.

The system controller 204 performs the functions of the GCS 200. The system controller 204 is depicted as a processing component such as a controller. The processing component comprises at least one processor 216 and a computer-readable storage device or media (such as memory 218) encoded with programming instructions for configuring the processing component. Within the system controller 204, the processor 216 and the memory 218 (having therein a program 220) form a novel synchronization engine that performs the described processing activities in accordance with the program 220, as is described in more detail below. The system controller 204 generates display signals that command and control the display unit 206.

The processor 216 may comprise any type of processor or multiple processors, any custom-made or commercially available processor, a central processing unit (CPU), a graphics processing unit (GPU), an application specific integrated circuit (ASIC), a field programmable gate array (FPGA), an auxiliary processor among several processors associated with the processing component, a semiconductor-based microprocessor (in the form of a microchip or chip set), any combination thereof, or generally any device for executing instructions to carry out the described operations, tasks, and functions by manipulating electrical signals representing data bits at memory locations in system memory, as well as other processing of signals.

The memory locations where data bits are maintained are physical locations that have particular electrical, magnetic, optical, or organic properties corresponding to the data bits. The memory 218 can be any type of suitable computer readable storage medium. For example, the memory 218 may include various types of dynamic random access memory (DRAM) such as SDRAM, the various types of static RAM (SRAM), the various types of non-volatile memory (PROM, EPROM, EEPROM, flash memory, or any other electric, magnetic, optical, or combination memory devices capable of storing data, some of which represent executable programming instructions, used by the processing component), and keep-alive memory (KAM), for example. KAM is a persistent or non-volatile memory that may be used to store various operating variables while the processor is powered down.

In certain examples, the memory 218 is located on and/or co-located on the same computer chip as the processor 216. Generally, the memory 218 maintains data bits and may be utilized by the processor 216 as storage and/or a scratch pad during operation. In the depicted embodiment, the memory 218 stores instructions and applications 222, and program 220, along with one or more configurable variables in stored variables 224. Information in the memory 218 may be organized and/or imported from an external source during an initialization step of a process; it may also be programmed via the user input mechanism 208.

During operation, the processor 216 loads and executes one or more programs, algorithms and rules embodied as instructions and applications 222 contained within the memory 218 and, as such, controls the general operation of the system controller 204 as well as GCS 200. In executing the process described herein, the processor 216 specifically loads and executes the novel program 220. Additionally, the processor 216 is configured to process received inputs (any combination of input from the communication system and fabric 210 and user input provided via user input mechanism 208), reference the database 226 in accordance with the program 220, and generate display commands that command and control the display unit 206 based thereon.

The program 220 include rules and instructions that, when executed, convert the system controller 204 (e.g., processor 216/memory 218) configuration into a fleet manager system that performs the functions, techniques, and processing tasks associated with identifying UAM vehicles to dispatch on missions based on identified mission priorities. In various embodiments, the fleet manager system is configured to: receive user input including an identification of a specific payload, a pickup location for the specific payload, a destination for the specific payload, a delivery time for payload delivery, and a mission priority for the specific payload; apply a fleet utilization algorithm with a plurality selection algorithms that correspond to the user-selectable mission priorities that determine the one or more UAM vehicles to dispatch on the mission; assign one or more UAM vehicles to transport the specific payload from the pickup location to the destination based on user selection of a user-selectable mission priority from the plurality of user-selectable mission priorities; and generate a human machine interface (HMI) configured for display on the display unit 206. In some embodiments, the HMI is configured to display a map that illustrates the pickup location, destination, and the one or more UAM vehicles assigned to transport the payload.

The program 220 may be stored in a functional form on computer readable media, for example, as depicted, in memory 218. While the depicted exemplary embodiment of the system controller 204 is described in the context of a fully functioning computer system, those skilled in the art will recognize that the mechanisms of the present disclosure are capable of being distributed as a program product.

As a program product, one or more types of non-transitory computer-readable signal bearing media may be used to store and distribute the program 220, such as a non-transitory computer readable medium bearing the program 220 and containing therein additional computer instructions for causing a computer processor (such as the processor 216) to load and execute the program 220. Such a program product may take a variety of forms, and the present disclosure applies equally regardless of the type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized as memory 218 and as program product time-based viewing of clearance requests in certain embodiments.

In various embodiments, the controller (e.g., processor 216/memory 218) configuration of the system controller 204 may be communicatively coupled (via a bus 232) to an input/output (I/O) interface 234, a database 226, and a disk 230. The bus 232 serves to transmit programs, data, status and other information or signals between the various components of the system controller 204. The bus 232 can be any suitable physical or logical means of connecting computer systems and components. This includes, but is not limited to, direct hard-wired connections, fiber optics, infrared and wireless bus technologies.

The database 226 and the disk 230 are computer readable storage media in the form of any suitable type of storage apparatus, including direct access storage devices such as hard disk drives, flash systems, floppy disk drives and optical disk drives. The database 226 may include an airport database (comprising airport features), a terrain database (comprising terrain features), and other databases. In combination, the features from the airport database and the terrain database are referred to map features. Information in the database 226 may be organized and/or imported from an external data source 214 during an initialization step of a process.

The I/O interface 234 enables communications with the system controller 204, as well as communications between the system controller 204 and other mobile vehicle components, and between the system controller 204 and the external data sources via the communication system and fabric 210. The I/O interface 234 may include one or more network interfaces and can be implemented using any suitable method and apparatus. In various embodiments, the I/O interface 234 is configured to support communication from an external system driver and/or another computer system. In one embodiment, the I/O interface 234 is integrated with the communication system and fabric 210 and obtains data from external data source(s) directly. Also, in various embodiments, the I/O interface 234 may support communication with technicians, and/or one or more storage interfaces for direct connection to storage apparatuses, such as the database 226. In some embodiments, the database 226 is part of the memory 218. In various embodiments, the database 226 is integrated, either within the system controller 204 or external to it.

It will be appreciated that the GCS 200 may differ from the embodiment depicted in FIG. 2. As mentioned, the fleet manager system can be integrated into a GCS 200; a portable electronic device (PED), such as a laptop computer, tablet computer, smartphone, or other PED; a fleet scheduler infrastructure 118, or other computing device accessible at a GCS center 114.

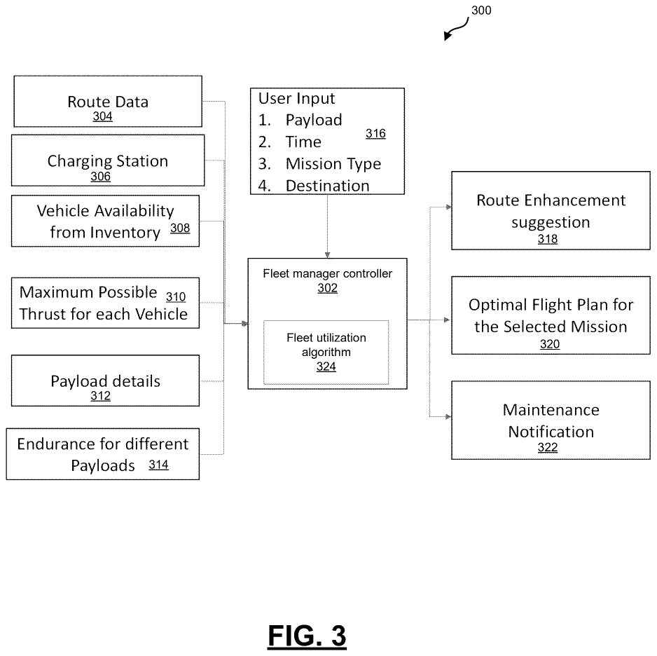

FIG. 3 is a block diagram depicting an example fleet manager system 300. The example fleet manager system 300 includes a fleet manager controller 302. The fleet manager controller 302 may be integrated into a GCS 200 (e.g., system controller 204); a portable electronic device (PED), such as a laptop computer, tablet computer, smartphone, or other PED; a fleet scheduler infrastructure 118; or other computing device accessible at a GCS center 114 or some other location. In various embodiments, the fleet manager controller 302 is a cloud-based device configured to provide fleet management functions for a UAM system.

The example fleet manager controller 302 is configured to receive input from a plurality of sources. In various embodiments, the fleet manager controller 302 is configured to input route data 304, charging station information 306, vehicle availability from inventory data 308, maximum possible thrust for each vehicle data 310, payload detail data 312, and endurance data for different payloads 314 from one or more databases. Some or all of the one or more databases may be co-located with the fleet manager controller 302 or may be accessible via the cloud.

The route data 304 may include, but is not limited to, airways, terrain data, power lines, weather information, and obstacle information. The charging station information 306 may include, but is not limited to, the capacity of the station such as number of ports, maximum power, maximum current, available voltage, and fast charging information. The vehicle availability from inventory data 308 may include, but is not limited to, the number of available vehicle, vehicle configuration data, maximum payload capacity, maximum range, and available batter power. The maximum possible thrust for each vehicle data 310 may include, but is not limited to, the maximum available thrust of each vehicle, maximum available thrust after cascading, and maximum available thrust after one motor failing. The payload detail data 312 may include, but is not limited to, the criticality of the payload, payload mass, and payload scheduled delivery time. The endurance data for different payloads 314 may include, but is not limited to, the endurance of the each vehicle when the vehicle is operating independently and the endurance of cascaded vehicles when they are operating as connected vehicles.

The example fleet manager controller 302 is further configured to input user input data 316 from a shipper who desires to utilize the services of a UAM vehicle to ship a payload, a ground operator 121, and/or a fleet operator 117. The user input data 316 may include payload data that identifies a specific payload, pickup and/or delivery time data for the specific payload, mission priority data, payload pickup location data, and payload destination data.

The example fleet manager controller 302 is further configured to apply a fleet utilization algorithm 324 having a plurality of selection algorithms that are selected for use based on user-selected mission priorities. The example fleet manager controller 302 is configured to make UAM vehicle determinations/assignments using the fleet utilization algorithm based on user-selected mission priorities. In particular, the example fleet manager controller 302 is configured to make UAM vehicle determinations/assignments for a specific mission using one of the plurality of selection algorithms that is associated with a user-selected mission priority.

In various embodiments, the user-selected mission priorities include one or more of: a first mission priority that prioritizes time efficiency; a second mission priority that prioritizes route efficiency; a third mission priority that prioritizes fleet efficiency; a fourth mission priority that prioritizes delivery urgency; and a fifth mission priority that prioritizes a single vehicle mission, wherein a single UAM vehicle is dispatched to carry the entire payload. In various embodiments, one or more UAM vehicles are allocated for mission completion to minimize payload wait time when the mission priority prioritizes time efficiency. In various embodiments, a UAM vehicle with sufficient payload carrying capacity is allocated for transporting a plurality of packages with different pickup locations along a route to different or the same destination when the mission priority prioritizes route efficiency. In various embodiments, a first UAM vehicle on a first mission is directed to drop its load at a station and divert to a second mission when a second UAM vehicle is available to complete the first mission and it is more efficient for the first UAM vehicle to complete the second mission than dispatching another UAM vehicle to complete the second mission when the mission priority prioritizes fleet efficiency. In various embodiments, a first UAM vehicle is dispatched to transport a first payload directly from a first pickup station to a first destination station without diversion to another station and without diversion to another mission when the mission priority prioritizes delivery urgency. In various embodiments, a single UAM vehicle is dispatched to carry the entire payload when the mission priority prioritizes a single vehicle mission. In various embodiments, when the user-selected mission priority prioritizes delivery urgency, a first UAM vehicle with sufficient payload carrying capacity is dispatched to transport a first payload directly from a first pickup station to a first destination station without stopping at an intermediate station and without diversion to another mission.

The example fleet manager controller 302 is further configured to generate a human machine interface (HMI) configured for display on a display device that illustrates an assignment of UAM vehicles to transport payloads from pickup locations to destination locations. In various embodiments, the HMI may be configured to display a map that illustrates pickup locations, destination locations, and the one or more UAM vehicles assigned to transport payloads. The example fleet manager controller 302 may be further configured to generate route enhancement suggestion data 318, an optimal flight plan for a selected mission data 320, and maintenance notification data 322.

In various embodiments, route enhancement suggestion data 318 may include, but is not limited to, the selection of an airway or route for a given origin and destination based on vehicle endurance, range, payload capacity and configuration. In various embodiments, an optimal flight plan for a selected mission data 320 may include, but is not limited to, the shortest distance, shortest time, less fuel consumption, and optimum altitude. In various embodiments, maintenance notification data 322 may include, but is not limited to, the last flown path, vehicle parameters, battery health, BITE data, and fault messages.

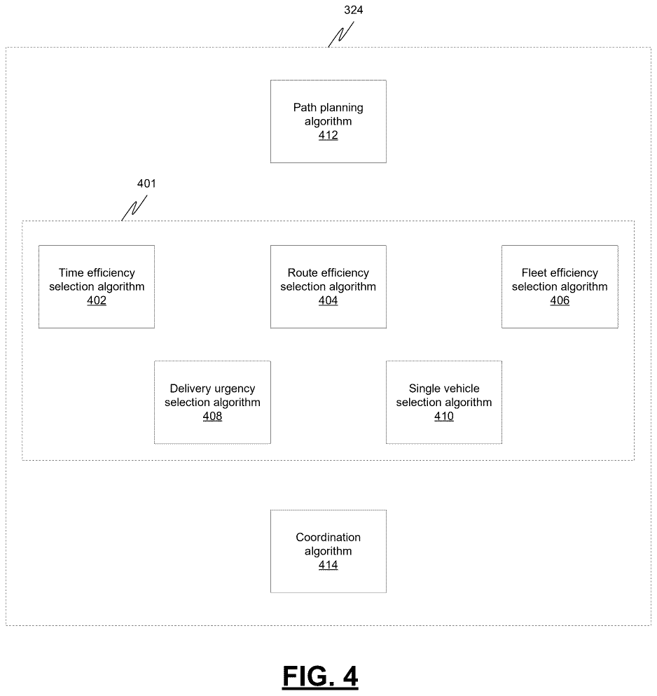

FIG. 4 is a block diagram depicting an example fleet utilization algorithm 324. The example fleet utilization algorithm 324 includes a plurality of user-selectable selection algorithms 401 and applies one of the plurality of different user-selectable selection algorithms 401 to select one or more UAM vehicles to dispatch on a mission. The plurality of user-selectable selection algorithms 401 in the example fleet utilization algorithm 324 includes a time-efficient selection algorithm 402, a route-efficient selection algorithm 404, a fleet-efficient selection algorithm 406, an emergency selection algorithm 408, and a single-vehicle selection algorithm 410. Each of these selection algorithms 401 is configured to select vehicles based on payload demand and ensuing battery availability. In various embodiments, the selection algorithms 401 use a combinatorial optimization algorithm that searches for the optimal sequence/integrations of UAM vehicles among all possible permutations.

The time-efficient selection algorithm 402 is configured to select one or more UAM vehicles for mission completion to minimize payload wait time at pickup locations or for the quickest delivery. In various embodiments, the time-efficient selection algorithm 402 is selected when a user-selected mission priority prioritizes time efficiency. In various embodiments, when the user-selected mission priority prioritizes time efficiency, a first UAM vehicle with sufficient payload carrying capacity for transport that is closer to a pickup station is selected over a second UAM vehicle with sufficient payload carrying capacity for transport that is further away from the pickup station.

The route-efficient selection algorithm 404 is configured to select one or more UAM vehicles with sufficient payload carrying capacity to transport multiple packages from different pickup locations and/or drop off locations along a common route. In various embodiments, the route-efficient selection algorithm 404 is selected when a user-selected mission priority prioritizes route efficiency. In various embodiments, when the user-selected mission priority prioritizes route efficiency, a first UAM vehicle is selected to transport a first payload along a first route from a first pickup station to a first destination, and to transport a second payload along a second route from a second pickup station to a second destination, wherein at least part of the first route overlaps with at least part of the second route. In various embodiments, when the user-selected mission priority prioritizes route efficiency, a UAM vehicle currently tasked with transporting a first payload along a route may be tasked with transporting a second payload along the route.

The fleet-efficient selection algorithm 406 is configured to select one or more UAM vehicles for missions based on a more efficient use of UAM vehicle fleet. As an example, a first UAM vehicle on a first mission may be directed to drop its load at a station and divert to a second mission when a second UAM vehicle is available to complete the first mission and it is more efficient for the first UAM vehicle to complete the second mission than dispatching another UAM vehicle to complete the second mission. This mission ensures the vehicle availability in all ports to serve for any incoming payload. The mission will be adjusted to ensure the service is available in all ports with minimum delay. In various embodiments the fleet-efficient selection algorithms 406, aims to ensure availability of vehicles in all stations or at least at a nearby station. In various embodiments, the fleet-efficient selection algorithm 406 is selected when a user-selected mission priority prioritizes fleet efficiency.

The emergency selection algorithm 408 is configured to select one or more UAM vehicles to complete a mission as soon as possible. As an example, UAM vehicle selection for transporting a payload from a first station to a second station may be made based on identifying a UAM vehicle with sufficient cargo transporting capability and sufficient battery capacity to directly transport the payload from the first station to the second station that can deliver the payload the soonest. The selected UAM vehicle will also be blocked from being dispatched to another mission. In various embodiments, the emergency selection algorithm 408 is selected when a user-selected mission priority prioritizes delivery urgency. In various embodiments, the emergency selection algorithm 408 is selected to minimize delivery time for a payload.

The single-vehicle selection algorithm 410 is configured to select one or more UAM vehicles for a mission based on ensuring that a single vehicle has sufficient cargo transporting capability and sufficient battery capacity to complete the mission. This mission ensures the quickest and most efficient way to carry a payload using a single vehicle that will carry the entire payload. In various embodiments, the single-vehicle selection algorithm 410 is selected when a user-selected mission priority prioritizes a single vehicle mission.

Other selection algorithms may be included in the plurality of selection algorithms and some of selection algorithms discussed above may not be included in a particular embodiment. Additionally, a selection algorithm can be customized based on a mission priority created by an operator or pilot.

One or more of the selection algorithms 401 may also be configured to cascade different types of vehicles in an efficient manner during a transport mission. For example, one UAM vehicle from a first category of UAM vehicles may be dispatched on a first leg of a mission and another UAM vehicle from a second category of UAM vehicles is dispatched on a second leg of the mission. This mission finds an optimum and efficient way to cascade different categories of vehicles such as eVTOL, hybrid VTOL, different categories of vehicles categorized based on energy usage (such as battery-operated vehicles, gasoline engine operated vehicles, and vehicles with Hybrid engines), different categories of vehicles categorized based on size (such as small, medium, large), different categories of vehicles categorized based on payload carrying capacity, or other different categories of vehicles.

Additionally, one or more of the selection algorithms 401 may also be configured to cascade vehicles with different payload-carrying capacities in an efficient manner during a transport mission. For example, two UAM vehicles, each with a 100 kg payload transport capability may be dispatched to jointly carry a 180 kg load. This mission finds the optimum and efficient way to cascade different categories of vehicles such as small, medium, and heavy vehicles (which are categorized based on their mass) or different categories of vehicles such as battery-operated vehicles, gasoline engine operated vehicles, and vehicles with Hybrid engines (which are categorized based on their energy usage).

The example fleet utilization algorithm 324 further includes a path planning algorithm 412. The path planning algorithm 412 is configured to generate a flight path for a payload from a start point to a destination point. In various embodiments, to generate the flight path, the path planning algorithm 412 is configured to partition a travel route from the start point to the destination point into one or more segments. Each segment begins and ends at a route node that is accessible by a plurality of transport vehicles in a fleet of vehicles. A first segment begins at the pickup location and ends at a waypoint, and a last segment begins at a waypoint and ends at the destination. In various embodiments, transport vehicles are stationed at various route nodes. In various embodiments, the pickup location and destination location for a payload are at different route nodes. Also, intermediate drop off points (where a payload is temporarily dropped off by one vehicle for pickup and transport by another vehicle) are located at a route node. Each segment is configured such that at least one vehicle can transport a payload across the segment. The partitioning can be done by using a graph-based algorithm, such as Dijkstra's algorithm, which finds the shortest path between two points on a map.

The example fleet utilization algorithm 324 also includes a coordination algorithm 414 for coordinating UAM vehicles when multiple UAM vehicles are dispatched to cooperatively transport a payload along a segment, such that safety constraints are satisfied. In various embodiments, the coordination algorithm comprises a distributed control algorithm that enables the cooperating UAM vehicles to communicate using the cloud and adjust their positions and velocities according to payload dynamics and collision avoidance rules.

The fleet utilization algorithm 324 may be invoked for each mission, after a set number of missions are requested, or at predetermined time increments. The user selected mission priority may be selected by a payload shipper or by a fleet operator.

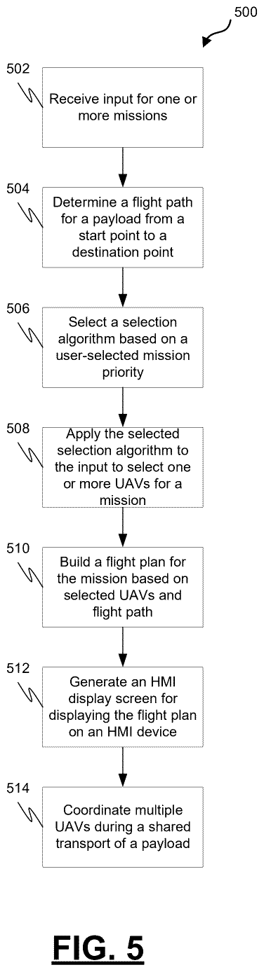

FIG. 5 is a process flow chart depicting an example method 500 in a system that utilizes a fleet utilization algorithm. The method 500 is merely an example and is not intended to limit the present disclosure beyond what is explicitly recited in the claims. Additional operations may be provided before, during, and after method 500, and some of the operations described can be moved, replaced, or eliminated for additional embodiments of method 500.

At operation 502, the example method 500 includes receiving input for one or more missions (operation 502). The input may include route data, charging station information, vehicle availability data, maximum possible thrust data for each vehicle, payload detail data, endurance data for different payloads, and a selected mission priority.

At operation 504, the example method 500 includes generating a flight path for a payload from a start point to a destination point (operation 504). In various embodiments, generating a flight path includes identifying a travel route from the start point to the destination point and partitioning the travel route into one or more segments, wherein each segment begins and ends at a route node that is accessible by at least one transport vehicle in a fleet of vehicles. In various embodiments, a route node comprises a transport station, such as a vertiport. In various embodiments, transport vehicles are stationed at various route nodes. In various embodiments, the pickup location and destination location for a payload are at different route nodes. Also, intermediate drop off points (where a payload is temporarily dropped off by one vehicle for pickup and transport by another vehicle) are located at a route node. Each segment is configured such that at least one vehicle can transport a payload across the segment. In various embodiments, the partitioning is performed using a graph-based algorithm, such as Dijkstra's algorithm, which finds the shortest path between two points on a map.

At operation 506, the example method 500 includes selecting a selection algorithm out a plurality of selection algorithms based on a user selected mission priority identified in the input (operation 506). In various embodiments, a selection algorithm is selected out a plurality of selection algorithms comprising one or more of: a time-efficient selection algorithm, a route-efficient selection algorithm, a fleet-efficient selection algorithm, an emergency selection algorithm, and a single-vehicle selection algorithm. In various embodiments, the selection algorithms use a combinatorial optimization algorithm that searches for the optimal sequence/integrations of UAM vehicles among all possible permutations.

In various embodiments, the time-efficient selection algorithm is selected when a user-selected mission priority prioritizes time efficiency. In various embodiments, the route-efficient selection algorithm is selected when a user-selected mission priority prioritizes route efficiency. In various embodiments, the fleet-efficient selection algorithm is selected when a user-selected mission priority prioritizes fleet efficiency. In various embodiments, the delivery-urgency selection algorithm is selected when a user-selected mission priority prioritizes delivery urgency. In various embodiments, the single-vehicle selection algorithm is selected when a user-selected mission priority prioritizes a single vehicle mission.

At operation 508, the example method 500 includes applying an appropriate selection algorithm to the input to select one or more UAM vehicles to a mission. In various embodiments, applying an appropriate selection algorithm comprises applying a time-efficient selection algorithm when the mission priority prioritizes time efficiency, applying a route-efficient selection algorithm when the mission priority prioritizes route efficiency, applying a fleet-efficient selection algorithm when the mission priority prioritizes fleet efficiency, applying an emergency selection algorithm when the mission priority prioritizes delivery urgency, and applying a single-vehicle selection algorithm when the mission priority prioritizes a single vehicle mission.

At operation 510, the example method 500 includes building a flight plan for the mission. In various embodiments, building a flight plan comprises identifying the flight path for the payload including route nodes, identifying pickup and drop of nodes, and identifying vehicles for transporting the payload from one node to another.

At operation 512, the example method 500 includes generating an HMI display screen for displaying the flight plan on an HMI device. In various embodiments, the HMI display screen identifies the flight path for the payload including route nodes, identifies pickup and drop of nodes, and identifies vehicles for transporting the payload from one node to another.

At operation 514, the example method 500 includes coordinating multiple UAM vehicles during a shared transport of a payload. In various embodiments, coordinating multiple vehicles include coordinating UAM vehicles when multiple UAM vehicles are dispatched to cooperatively transport a payload along a segment such that safety constraints are satisfied. In various embodiments, the coordinating comprises applying a distributed control algorithm that enables the cooperating UAM vehicles to communicate using the cloud and adjust their positions and velocities according to payload dynamics and collision avoidance rules.

The example method 500 may be invoked for each mission, after a set number of missions are requested, or at predetermined time increments. The user selected mission priority may be selected by a payload shipper or by a fleet operator.

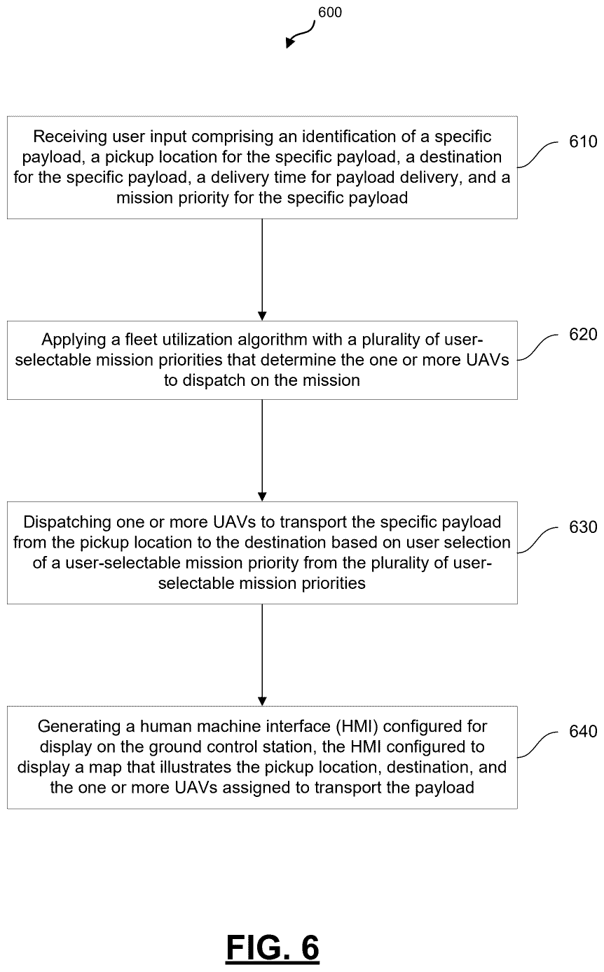

FIG. 6 is a process flow chart of an example method 600 in an Urban Air Mobility (UAM) system. The method 600 is merely an example and is not intended to limit the present disclosure beyond what is explicitly recited in the claims. Additional operations may be provided before, during, and after method 600, and some of the operations described can be moved, replaced, or eliminated for additional embodiments of method 600.

At operation 610, the example method 600 includes receiving user input. In various embodiments the input comprises an identification of a specific payload, a pickup location for the specific payload, a destination for the specific payload, a delivery time for payload delivery, and a mission priority for the specific payload.

At operation 620, the example method 600 includes applying a fleet utilization algorithm with a plurality of different selection algorithms that determine the one or more UAM vehicles to dispatch on the mission. In various embodiments, the plurality of selection algorithms comprises one or more of: a time-efficient selection algorithm, a route-efficient selection algorithm, a fleet-efficient selection algorithm, an emergency selection algorithm, and a single-vehicle selection algorithm.

At operation 630, the example method 600 includes dispatching one or more UAM vehicles to transport the specific payload from the pickup location to the destination based on user selection of a user-selectable mission priority from a plurality of user-selectable mission priorities. In various embodiments, the time-efficient selection algorithm is applied to select one or more UAM vehicles for dispatch when a user-selected mission priority prioritizes time efficiency. In various embodiments, the route-efficient selection algorithm is applied to select one or more UAM vehicles for dispatch when a user-selected mission priority prioritizes route efficiency. In various embodiments, the fleet-efficient selection algorithm is applied to select one or more UAM vehicles for dispatch when a user-selected mission priority prioritizes fleet efficiency. In various embodiments, the delivery-urgency selection algorithm is applied to select one or more UAM vehicles for dispatch when a user-selected mission priority prioritizes delivery urgency. In various embodiments, the single-vehicle selection algorithm is applied to select one or more UAM vehicles for dispatch when a user-selected mission priority prioritizes a single vehicle mission.

At operation 640, the example method 600 includes generating a human machine interface (HMI) configured for display on a ground control station. In various embodiments, the HMI is configured to display a map that illustrates the pickup location, destination, and the one or more UAM vehicles assigned to transport the payload.

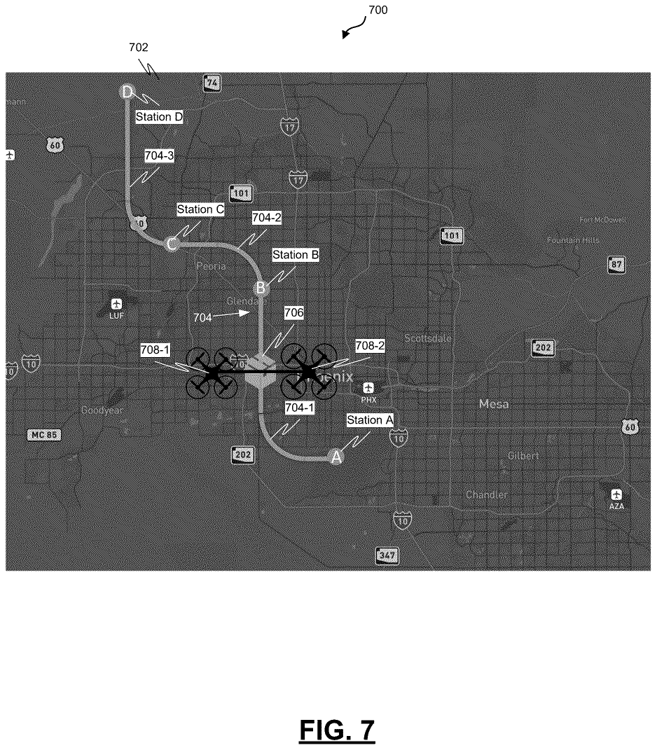

FIG. 7 is a diagram depicting an example HMI display 700 generated by a fleet manager controller for an operating scenario. The example HMI display 700 includes a two-dimensional (2-D) map 702 and a flight path 704 with three flight segments (704-1, 704-2, 704-3) between four nodes (station A, Station B, Station C, and Station D).

In this example, any one of a time efficient mission priority, a route efficient mission priority, or a fleet efficient mission priority may have been selected. A payload 706 of 200 kg is to be carried from station A to station B. The currently available vehicles in the fleet inventory, however, have a payload transport capability of up to 140 kg. The fleet manager controller selected the required number of vehicles (two in this case) needed for transporting the payload 706 and a docking method (e.g., parallel docking) for the given payload 706 and destination. The two vehicles (708-1 and 708-2) work cooperatively to transport the payload and with each of the two vehicles carrying a load of 100 kg.

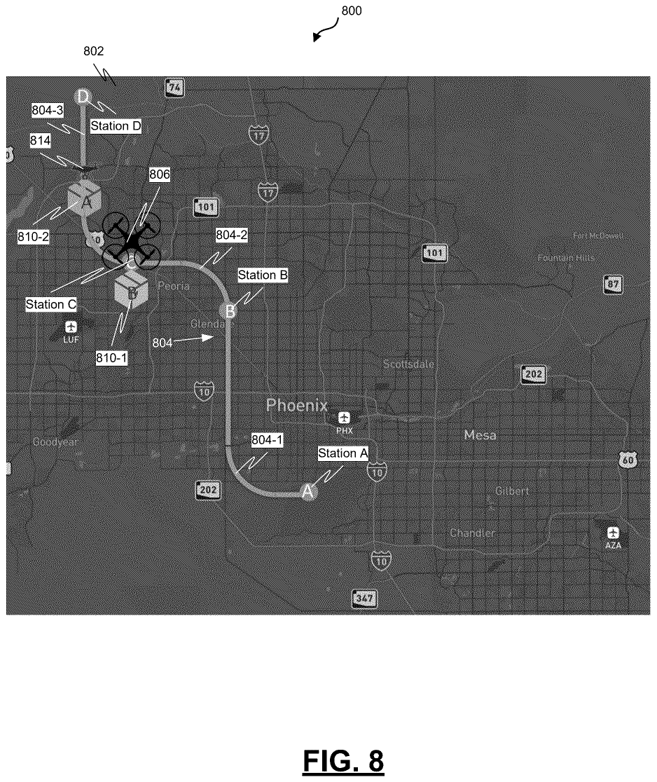

FIG. 8 is a diagram depicting an example HMI display 800 generated by a fleet manager controller for an operating scenario. The example HMI display 800 includes a 2-D map 802 and a flight path 804 with three flight segments (804-1, 804-2, 804-3) between four nodes (Station A, Station B, Station C, and Station D).

In this example, a fleet efficient mission priority may have been selected, and two 100 kg payloads (payload 810-1 and payload 810-2) are to be transported from station B to station C. A currently available vehicle 806 can carry up to 280 kg. Upon selection of the Mission, the cloud-based fleet manager generates the required number of vehicles (1 in this example) and its docking method for the given payload and destination. In this case, the vehicle 806, which can carry 280 kg, is selected and used for the mission from Station B to Station C. 100 kg payload 810-1 is delivered at Station C and a smaller vehicle 814 is chosen to transport the payload 810-2 from Station C to Station D to complete the mission for the remaining 100 kg payload. The fleet manager controller chooses vehicle 814 to transport the payload 810-2 from Station C to Station D, because it may be a more efficient use of the fleet to have the smaller vehicle 814 transport the payload 810-2 than it would be to have the larger vehicle 806 transport the payload 810-2 to Station D.

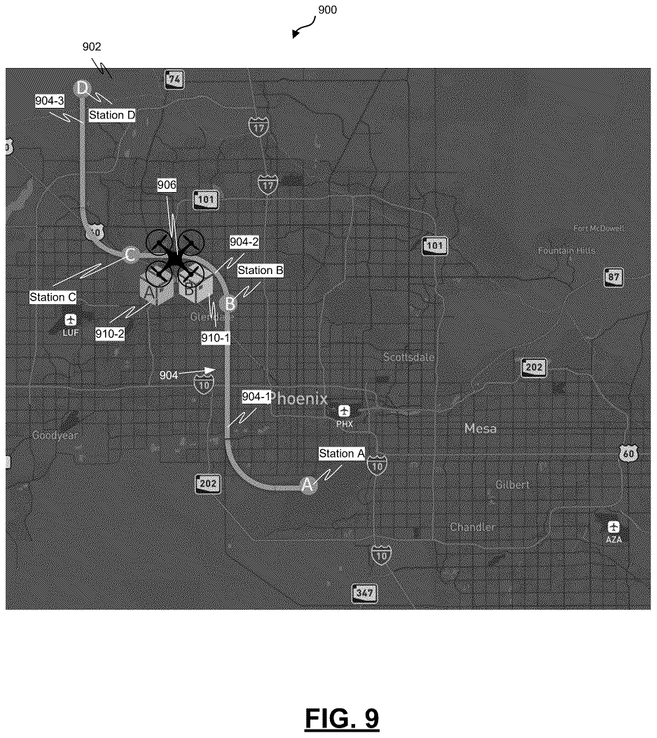

FIG. 9 is a diagram depicting an example HMI display 900 generated by a fleet manager controller for an operating scenario. The example HMI display 900 includes a 2-D map 902 and a flight path 904 with three flight segments (904-1, 904-2, 904-3) between four nodes (Station A, Station B, Station C, and Station D).

In this example, a route efficient mission priority may have been selected, and two 100 kg payloads (payload 910-1 and payload 910-2) are to be carried from station B to station C and one of the 100 kg payloads (payload 910-2) is to be carried from station C to D. The currently available vehicle 906 at station B can carry up to 280 kg. Upon selection of the Mission, the fleet manager controller generates the required number of vehicles (1 in this example) and its docking method for the given payload and destination. In this case, the single-vehicle 906 which is capable of carrying 280 kg is selected and used for the mission. When the vehicle 906 reaches station C, one 100 kg payload 910-1 is dropped, and the same vehicle 906 continues the mission to station D with the second payload 910-2.

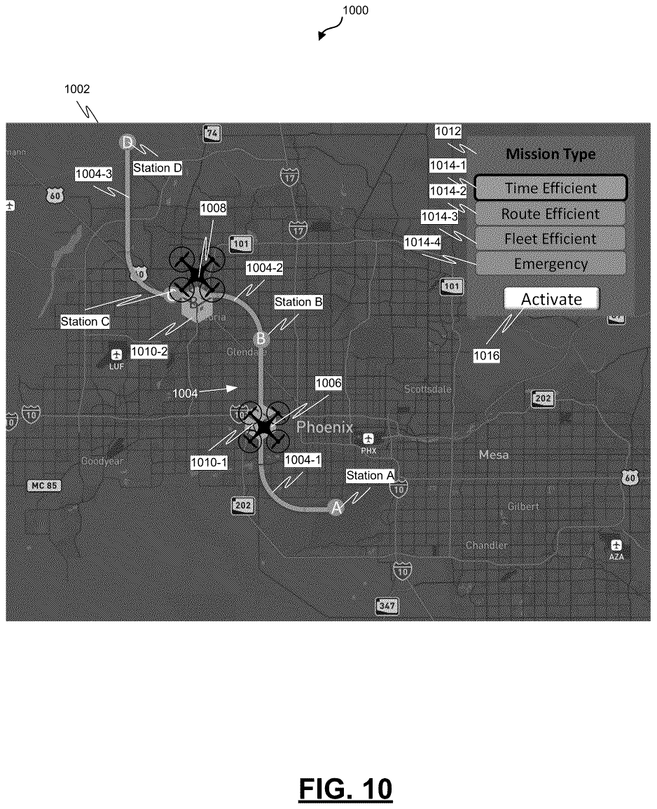

FIG. 10 is a diagram depicting an example HMI display 1000 generated by a fleet manager controller for an operating scenario. The example HMI display 1000 includes a 2-D map 1002 and a flight path 1004 with three flight segments (1004-1, 1004-2, 1004-3) between four nodes (Station A, Station B, Station C, and Station D).

In this example, a time efficient mission priority has been selected. A first payload 1010-1 of 50 kg was added to station A for transport from station A to station D, and a second payload 1010-2 of 50 kg was added to station B for transport from station B to station D. A first vehicle 1006 with a 100 kg payload carrying capacity and sufficient battery capacity for transport to station D is scheduled to transport the first payload 1010-1 of 50 kg from station A to D. Instead of suggesting that the first vehicle pick up the second payload 1010-2 from station B and transport both payloads to station D, the fleet manager controller selects a second vehicle 1008 to transport the second payload 1010-2 from station B to station C. This mission utilized two vehicles and ensured minimal waiting time for the payloads.

The HMI display 1000 also includes a graphical user interface (GUI) widget (referred to herein as mission type selection widget 1012) with selectable buttons for selecting one of a plurality of mission types. In this example, the mission type selection widget 1012 includes a time efficient mission button 1014-1, a route efficient mission button 1014-2, a fleet efficient mission button 1014-3 and an emergency mission button 1014-4 for use by an operator to select a mission type. The mission type selection widget 1012 also includes an activate button 1016 for use by an operator to activate the fleet manager controller to suggest vehicles for use in transporting payloads in accordance with a selected mission type. In this example, the time efficient mission button 1014-1 has been selected.

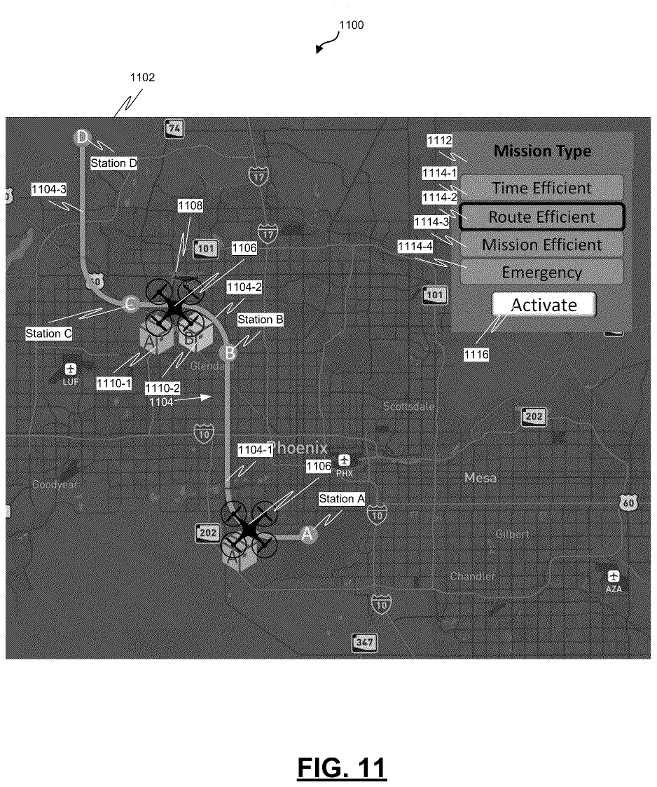

FIG. 11 is a diagram depicting an example HMI display 1100 generated by a fleet manager controller for an operating scenario. The example HMI display 1100 includes a 2-D map 1102 and a flight path 1104 with three flight segments (1104-1, 1104-2, 1104-3) between four nodes (Station A, Station B, Station C, and Station D).

In this example, a route-efficient mission priority has been selected. A first payload 1010-1 of 50 kg was added to station A for transport from station A to station D, and a second payload 1010-2 of 50 kg was added to station B for transport from station B to station D. A first vehicle 1106 with a 100 kg payload carrying capacity and sufficient battery capacity for transport to station D is selected to transport the first payload 1110-1 of 50 kg from station A to B, pick up the second payload 1110-2 of 50 kg at station B, and transport both the first payload 1110-1 and the second payload 1110-2 from station B to station D. This mission utilizes only one vehicle and ensures that a second vehicle 1108 is available to transport any additional payloads added to station A or B.

The HMI display 1100 also includes a GUI widget (referred to herein as mission type selection widget 1112) with selectable buttons for selecting one of a plurality of mission types. In this example, the mission type selection widget 1112 includes a time efficient mission button 1114-1, a route efficient mission button 1114-2, a fleet efficient mission button 1114-3 and an emergency mission button 1114-4 for use by an operator to select a mission type. The mission type selection widget 1112 also includes an activate button 1116 for use by an operator to activate the fleet manager controller to suggest vehicles for use in transporting payloads in accordance with a selected mission type. In this example, the route efficient mission button 1114-2 has been selected.

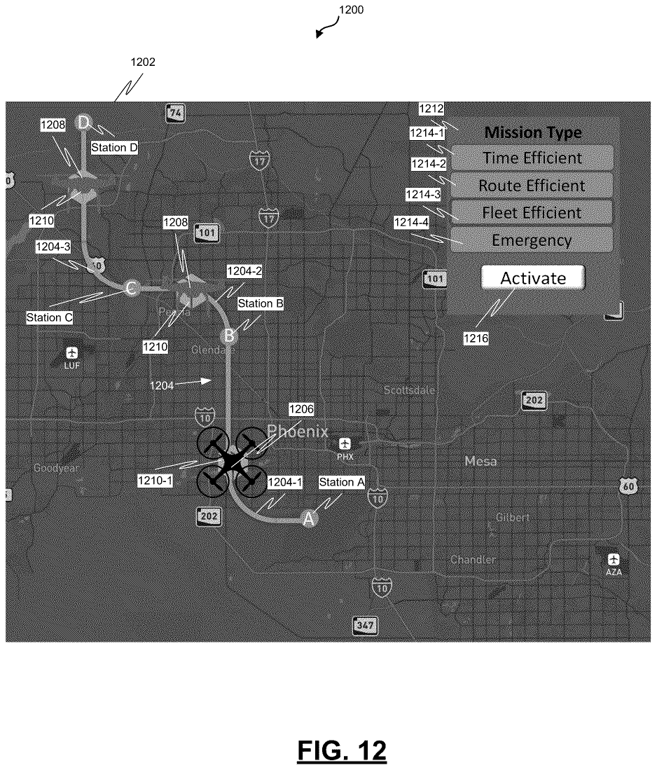

FIG. 12 is a diagram depicting an example HMI display 1200 generated by a fleet manager controller for an operating scenario. The example HMI display 1200 includes a 2-D map 1202 and a flight path 1204 with three flight segments (1204-1, 1204-2, 1204-3) between four nodes (Station A, Station B, Station C, and Station D).

In this example, a fleet efficient mission priority has been selected. A goal when a fleet efficient mission priority is selected may be to fulfil a mission in a way that ensures that a vehicle is available for use at all the stations for future missions. A payload 1210 has been dropped at station A for transport to station D. Initially, a first vehicle 1206 is available at station A, a second vehicle 1208 is available at station C, and a third vehicle (not shown) is available at station D with no vehicle available at station B. In this scenario, the fleet manager controller may select the first vehicle 1206 at station A to transport the payload 1210 from station A to station B, drop the payload 1210 at station B, and return to station A. The fleet manager controller may also select the second vehicle 1208 at station C to fly to station B, while the payload 1210 is in route to station B, to pick up the payload 1210 and transport the payload 1210 to station D. This allows the first vehicle 1206 to be available to transport any new payloads dropped at station A or B, and allows the third vehicle at station D to be available to transport any new payloads dropped at station C or D.

The HMI display 1200 also includes a GUI widget (referred to herein as mission type selection widget 1212) with selectable buttons for selecting one of a plurality of mission types. In this example, the mission type selection widget 1212 includes a time efficient mission button 1214-1, a route efficient mission button 1214-2, a fleet efficient mission button 1214-3 and an emergency mission button 1214-4 for use by an operator to select a mission type. The mission type selection widget 1212 also includes an activate button 1216 for use by an operator to activate the fleet manager controller to suggest vehicles for use in transporting payloads in accordance with a selected mission type. In this example, the fleet efficient mission button 1214-3 has been selected.

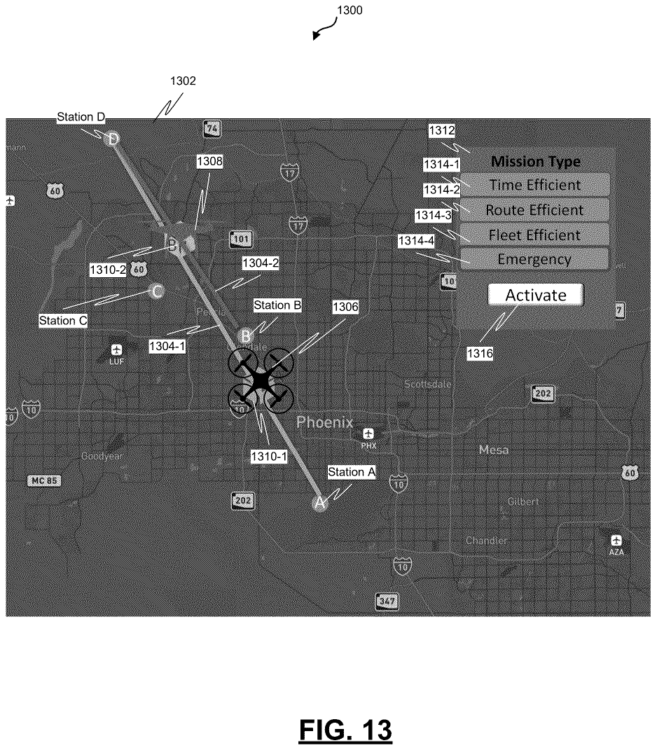

FIG. 13 is a diagram depicting an example HMI display 1300 generated by a fleet manager controller for an operating scenario. The example HMI display 1300 includes a 2-D map 1302 and four nodes (Station A, Station B, Station C, and Station D).

In this example, an emergency mission priority has been selected. A goal when an emergency mission priority is selected may be to transport a payload as quickly as possible to a destination. A first payload 1310-1 of 50 kg was dropped at station A for transport to station D, and a second payload 1310-2 of 50 kg was dropped at station B for transport to station D. After activation of the emergency mission priority, a first straight path 1304-1 is drawn from station A to station D, and a second straight path 1304-2 is drawn from station B to station D. A first vehicle 1306 is selected to transport the first payload 1310-1 along the first straight path 1304-1 from station A to station D, and a second vehicle 1308 is selected to transport the second payload 1310-2 along the second straight path 1304-2 from station B to station D.

The HMI display 1300 also includes a GUI widget (referred to herein as mission type selection widget 1312) with selectable buttons for selecting one of a plurality of mission types. In this example, the mission type selection widget 1312 includes a time efficient mission button 1314-1, a route efficient mission button 1314-2, a fleet efficient mission button 1314-3 and an emergency mission button 1314-4 for use by an operator to select a mission type. The mission type selection widget 1312 also includes an activate button 1316 for use by an operator to activate the fleet manager controller to suggest vehicles for use in transporting payloads in accordance with a selected mission type. In this example, the emergency mission button 1314-4 has been selected.

In various embodiments, the apparatus, systems, techniques, and articles disclosed herein can provide cloud-based route optimization based on a user-selected payload and destination. In various embodiments, the apparatus, systems, techniques, and articles disclosed herein can provide cloud-based vehicle selection and integration for a given payload and destination. In various embodiments, the apparatus, systems, techniques, and articles disclosed herein can allocate a sufficient number of vehicles and types of vehicles based on mission type. In various embodiments, the apparatus, systems, techniques, and articles disclosed herein can identify a single or multiple vehicles to transport a detachable cargo payload and/or passenger capsule based on the mass of the cargo payload and/or passenger capsule.

In various embodiments, the apparatus, systems, techniques, and articles disclosed herein can provide cloud-based maintenance suggestions and cloud-based charging station recommendations. In various embodiments, the apparatus, systems, techniques, and articles disclosed herein can provide fleet management by a cloud-based system for a variety of different types of vehicles such as battery-operated vehicles, gasoline engine operated vehicles, and vehicles with Hybrid engines for better UAM vehicle usage efficiency. In various embodiments, the apparatus, systems, techniques, and articles disclosed herein can provide databases that are stored in the cloud, wherein missions are computed based on the cloud data during pre-flight.

In various embodiments, the apparatus, systems, techniques, and articles disclosed herein can improve vehicle range and endurance by cascading multiple vehicles to complete a mission. In various embodiments, the apparatus, systems, techniques, and articles disclosed herein can provide shorter flight time for mission-critical deliveries. In various embodiments, the apparatus, systems, techniques, and articles disclosed herein can provide an HMI that provides a preview of routes in a single view to ease the selection of vehicles by an operator.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An Urban Air Mobility (UAM) system comprising:
a plurality of UAM vehicles distributed at a plurality of UAM stations at different locations;
a ground control station comprising a display screen and configured for use by one or more ground control station operators to dispatch one or more UAM vehicles from the plurality of UAM vehicles on a mission; and
a fleet manager system comprising a processor configured by programming instructions to:
receive user input comprising an identification of a specific payload, a pickup location for the payload, a destination for the payload, and a user-selected mission priority for the payload from a plurality of user-selectable mission priorities;
apply a fleet utilization algorithm with a plurality of different selection algorithms that determine the one or more UAM vehicles to dispatch on a mission;
select an appropriate selection algorithm out of the plurality of different selection algorithms based on the user-selected mission priority;
apply the appropriate selection algorithm to the user input to select the one or more UAM vehicles to transport the specific payload; and
generate a human machine interface (HMI) display configured for display on the ground control station, the HMI display configured to illustrate the pickup location, destination, and the one or more UAM vehicles assigned to transport the specific payload.

2. The UAM system of claim 1, wherein the plurality of user-selectable mission priorities comprise a plurality of:
a first mission priority that prioritizes time efficiency;
a second mission priority that prioritizes route efficiency;
a third mission priority that prioritizes fleet efficiency;
a fourth mission priority that prioritizes delivery urgency; and
a fifth mission priority that prioritizes a single vehicle mission, wherein a single UAM vehicle is dispatched to carry the payload.

3. The UAM system of claim 2, wherein the plurality of different selection algorithms comprise a plurality of a time-efficient selection algorithm, a route-efficient selection algorithm, a fleet-efficient selection algorithm, an emergency selection algorithm, and a single-vehicle selection algorithm, and wherein:
the time-efficient selection algorithm is selected when a user-selected mission priority prioritizes time efficiency;
the route-efficient selection algorithm is selected when a user-selected mission priority prioritizes route efficiency;
the fleet-efficient selection algorithm is selected when a user-selected mission priority prioritizes fleet efficiency;
the emergency selection algorithm is selected when a user-selected mission priority prioritizes delivery urgency; and
the single-vehicle selection algorithm is selected when a user-selected mission priority prioritizes a single vehicle mission.

4. The UAM system of claim 1, wherein the HMI display comprises:
a two-dimensional (2-D) map; and
a GUI widget displayed over the 2-D map, the GUI widget configured for user selection of one of the plurality of user-selectable mission priorities.

5. The UAM system of claim 4, wherein the GUI widget further comprises a selectable element that when selected causes the fleet manager system to assign the one or more UAM vehicles to transport the specific payload based on the user-selected mission priority.

6. The UAM system of claim 1, wherein when the user-selected mission priority prioritizes time efficiency, the fleet manager system dispatches one or more UAM vehicles to transport the specific payload based on minimizing waiting time at the pickup location.

7. The UAM system of claim 1, wherein when the user-selected mission priority prioritizes route efficiency, the fleet manager system is configured to dispatch a UAM vehicle on a first mission to transport the specific payload on a second mission when the UAM vehicle has sufficient energy capacity and payload carrying capacity to complete both the first mission and the second mission.

8. The UAM system of claim 1, wherein when the user-selected mission priority prioritizes fleet efficiency, the fleet manager system is configured to dispatch a UAM vehicle based on optimizing UAM vehicle availability at all stations.

9. The UAM system of claim 1, wherein when the user-selected mission priority prioritizes delivery urgency, the fleet manager system is configured to dispatch a UAM vehicle based on minimizing delivery time of the specific payload.

10. A method in an Urban Air Mobility (UAM) system, the method comprising:
receiving user input comprising an identification of a specific payload, a pickup location for the payload, a destination for the payload, and a user-selected mission priority for the payload from a plurality of user-selectable mission priorities;
applying a fleet utilization algorithm with a plurality of different selection algorithms that determine one or more UAM vehicles to dispatch on a mission;
selecting an appropriate selection algorithm out of the plurality of different selection algorithms based on the user-selected mission priority;
applying the appropriate selection algorithm to the user input to select the one or more UAM vehicles to transport the specific payload; and
generate a human machine interface (HMI) display configured for display on a display device, the HMI display comprising a map that illustrates the pickup location, destination, and the one or more UAM vehicles assigned to transport the specific payload.

11. The method of claim 10, wherein the HMI display comprises:
a two-dimensional (2-D) map; and
a GUI widget displayed over the 2-D map, the GUI widget configured for user selection of one of the plurality of user-selectable mission priorities.

12. The method of claim 10, wherein the plurality of user-selectable mission priorities comprise a plurality of:
a first mission priority that prioritizes time efficiency;
a second mission priority that prioritizes route efficiency;
a third mission priority that prioritizes fleet efficiency;
a fourth mission priority that prioritizes delivery urgency; and
a fifth mission priority that prioritizes a single vehicle mission, wherein a single UAM vehicle is dispatched to carry the payload.

13. The method of claim 12, wherein the plurality of different selection algorithms comprise a plurality of a time-efficient selection algorithm, a route-efficient selection algorithm, a fleet-efficient selection algorithm, an emergency selection algorithm, and a single-vehicle selection algorithm, and wherein selecting an appropriate selection algorithm comprises:
selecting the time-efficient selection algorithm when the user-selected mission priority prioritizes time efficiency;
selecting the route-efficient selection algorithm when the user-selected mission priority prioritizes route efficiency;
selecting the fleet-efficient selection algorithm when the user-selected mission priority prioritizes fleet efficiency;
selecting the emergency selection algorithm when the user-selected mission priority prioritizes delivery urgency; and
selecting the single-vehicle selection algorithm when the user-selected mission priority prioritizes a single vehicle mission.

14. The method of claim 10, further comprising dispatching a first UAM vehicle with sufficient payload carrying capacity for transport that is closer to a pickup station over dispatching a second UAM vehicle with sufficient payload carrying capacity for transport that is further away from the pickup station when the user-selected mission priority prioritizes time efficiency.

15. The method of claim 10, further comprising dispatching a first UAM vehicle to transport a first payload along a first route from a first pickup station to a first destination and dispatching the first UAM vehicle to transport a second payload along a second route from a second pickup station to a second destination, wherein at least part of the first route overlaps with at least part of the second route, when the user-selected mission priority prioritizes route efficiency.

16. The method of claim 10, further comprising dispatching a first UAM vehicle with sufficient payload carrying capacity to transport a first payload directly from a first pickup station to a first destination station without stopping at an intermediate station and without diversion to another mission when the user-selected mission priority prioritizes delivery urgency.

17. The method of claim 10, further comprising instructing a first UAM vehicle on a first mission to drop a first payload at a station other than a destination station and instructing the first UAM vehicle to divert to a second mission when a second UAM vehicle is available to complete the first mission and it is more efficient for the first UAM vehicle to complete the second mission than dispatching another UAM vehicle to complete the second mission, when the user-selected mission priority prioritizes fleet efficiency.

18. The method of claim 10, further comprising dispatching a first UAM vehicle with sufficient payload carrying capacity for transport that is closer to a pickup station before dispatching a second UAM vehicle with sufficient payload carrying capacity for transport that is further away from the pickup station to transport the payload, when a user-selected, user-selectable mission priority prioritizes time efficiency.

19. An Urban Air Mobility (UAM) system comprising:
a plurality of UAM vehicles distributed at a plurality of UAM vehicle stations at different locations;
a ground control station comprising a display screen and configured for use by one or more ground control station operators to dispatch one or more UAM vehicles from the plurality of UAM vehicles on a mission; and
a fleet manager system comprising a processor configured by programming instructions to:
receive user input comprising an identification of a specific payload, a pickup location for the specific payload, a destination for the specific payload, a delivery time for payload delivery, and a mission type;
partition a flight path from the pickup location to the destination into a plurality of segments, wherein a first segment begins at the pickup location and ends at a waypoint and a last segment begins at a waypoint and ends at the destination;
assign one or more UAM vehicles to transport the specific payload along one or more segments based on an assigned mission priority;
wherein when the assigned mission priority prioritizes time efficiency, the fleet manager system selects one or more UAM vehicles to transport the specific payload based on minimizing waiting time at the pickup location and any waypoint;
wherein when the assigned mission priority prioritizes route efficiency, the fleet manager system selects one or more UAM vehicles currently tasked with transporting another payload along the one or more segments to transport the specific payload based on energy capacity and payload carrying capacity of the one or more UAM vehicles;
wherein when the assigned mission priority prioritizes fleet efficiency, the fleet manager system selects one or more UAM vehicles based on optimizing UAM vehicle availability at UAM vehicle stations;
wherein when the assigned mission priority prioritizes delivery urgency, the fleet manager system selects one or more UAM vehicles based on minimizing delivery time for the specific payload; and
generate a human machine interface (HMI) display configured for display on the ground control station, the HMI display configured to illustrate the pickup location, destination, the plurality of segments, and the one or more UAM vehicles selected to transport the payload.

20. The UAM system of claim 19, wherein the HMI display comprises:
a two-dimensional (2-D) map; and
a GUI widget displayed over the 2-D map, the GUI widget configured for user selection of one of a plurality of user-selectable mission priorities.
